(19) United States
(12) Patent Application Publication
(10) Pub. No.: US 2014/0070996 A1
(43) Pub. Date: Mar. 13, 2014

(54) METHOD AND APPARATUS FOR FACILITATING DIRECTION FINDING

(71) Applicant: Nokia Corporation, Espoo (FI)

(72) Inventors: Jarkko Kneckt, Espoo (FI); Jukka Reunamäki, Tampere (FI); Antti Kainulainen, Nummela (FI); Heikki Berg, Seinajoki (FI); Mauri Honkanen, Tampere (FI)

(73) Assignee: Nokia Corporation, Espoo (FI)

(21) Appl. No.: 14/116,826

(22) PCT Filed: May 16, 2011
(86) PCT No.: PCT/FI2011/050444

§ 371 Date: Nov. 11, 2013

(51) Int. Cl. G01S 3/14

(52) U.S. Cl. CPC G01S 3/14
USPC 342/386; 342/417

(57) ABSTRACT

In a non-limiting and example embodiment, a method is provided for facilitating direction calculation, comprising: detecting, by an apparatus at least one indication frame from another apparatus, determining properties associated with transmission of at least one subsequent frame from the another apparatus on the basis of the at least one indication frame, and gathering measurement information for direction calculation on the basis of the determined properties and the at least one subsequent frame from the another apparatus.

### FIELD

The present invention relates to facilitation of direction finding, and in particular for facilitating calculation of direction of a radio device on the basis of radio signals transmitted or received by the device.

### BACKGROUND

A growing number of various location-related services are available for wireless devices, such as route determination, tracking, location-related social networking, local advertising, etc. There is a variety of technologies available for implementing positioning. For example, devices may incorporate global positioning system (GPS) receivers to determine position on the basis receive signals from satellites. Methods also exist for determining location on the basis of signals from other terrestrial radio devices.

Currently applied methods for determining device location in wireless local area networks are based on estimating distance from multiple access points (AP) to a single station (STA) and then estimating the possible location of the STA. However, the accuracy of such methods can be poor, since the estimation is mostly based on received signal strength measurement. Measurements also need to be carried out from multiple APs, and the approach is therefore usable only in a network with multiple APs.

### SUMMARY

Various aspects of examples of the invention are set out in the claims.

According to a first embodiment, there is provided a method, comprising: detecting, by an apparatus, at least one indication frame from another apparatus, determining properties associated with transmission of at least one subsequent frame from the another apparatus on the basis of the at least one indication frame, and gathering measurement information for direction calculation on the basis of the determined properties and the at least one subsequent frame from the another apparatus.

According to a second embodiment, there is provided a method, comprising: generating at least one indication frame indicating properties associated with transmission of at least one subsequent frame usable for direction calculation, transmitting the at least one indication frame for at least one other apparatus, and transmitting at least one subsequent frame usable for direction calculation in the at least one other apparatus in accordance with the properties indicated in the indication frame.

According to a third embodiment, there is provided an apparatus configured to carry out the method of the first and/or second embodiment.

The invention and various embodiments of the invention provide several advantages, which will become apparent from the detailed description below.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a wireless communications system;

FIGS. 2a and 2b illustrate methods according to some embodiments;

FIGS. 3 and 4 illustrate direction measurement examples;

FIGS. 5 and 6 illustrate transmission of information usable for direction measurement according to some embodiments;

FIG. 7 illustrates sequence of frame and acknowledgement exchange for direction measurement;

FIGS. 8a, 8b, 8c, and 8d illustrate indication frame related information elements according to an embodiment; and

FIG. 9 illustrates a mobile communications device according to an embodiment.

### DETAILED DESCRIPTION

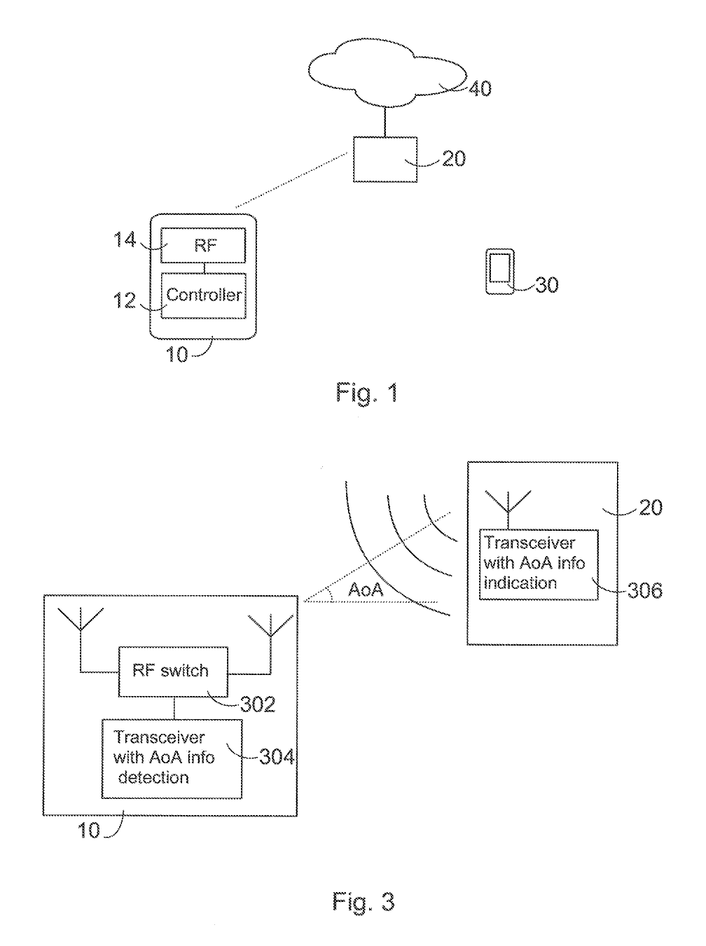

FIG. 1 illustrates an example of a wireless communication system including radio devices, such as devices supporting IEEE 802.11 features. While some embodiments are described with reference to IEEE 802.11 and, particularly, IEEE 802.11n, it should be appreciated that other embodiments are applicable to networks based on other specifications, such as other versions of the IEEE 802.11 (e.g. the 802.11ac), WiMAX (Worldwide Interoperability for Microwave Access), UMTS LTE (Long-term Evolution for Universal Mobile Telecommunication System), and other networks capable of providing information usable for direction measurement.

Mobile devices 10, 30 may associate with an access point (AP) or base station 20 and form an infrastructure basic service set (BSS). In some embodiments, the devices 10, 30 are IEEE 802.11 WLAN stations (STA). The AP 20 may be a fixed or mobile AP. The AP 20 typically provides access to other networks 40, e.g. the Internet. In another embodiment, at least one of the BSSs is an independent BSS (IBSS) or a mesh BSS (MBSS) without a dedicated AP, and in such embodiments the mobile device 10 may be a non-access-point terminal station. There may also be other WLANs or other types of access networks available in the neighborhood.

Given the limitations of device location tracking based on based on estimated distances from multiple APs, it would be advantageous to apply measurement of radio signal directions for positioning. However, e.g. calculation of angle of arrival (AoA) has not been applied to consumer devices, such as mobile phones, due to practical constraints. There may not be not sufficient space in small-size handheld devices for multiple antenna elements or multiple receiver signal chains to enable antenna-array reception in a manner described above. However, new tightly integrated multi-antenna modules capable of performing fast antenna switching during transmission of a known reference signal have become available to enable direction finding also in small devices. In some cases it may be possible to use already available signals and message structures of standardized radios, but they do not necessarily have long enough/many enough known signal sequences with beneficial properties to enable accurate direction finding. Established and preferably standardized procedures would be very much appreciated to facilitate direction calculation, in particular for WLAN networks and on the basis of WLAN signals.

According to some embodiments of the present invention, a specific indication frame is used to provide a priori information on transmission of subsequent one or more frames used for calculating direction to a device transmitting the subsequent frame(s).

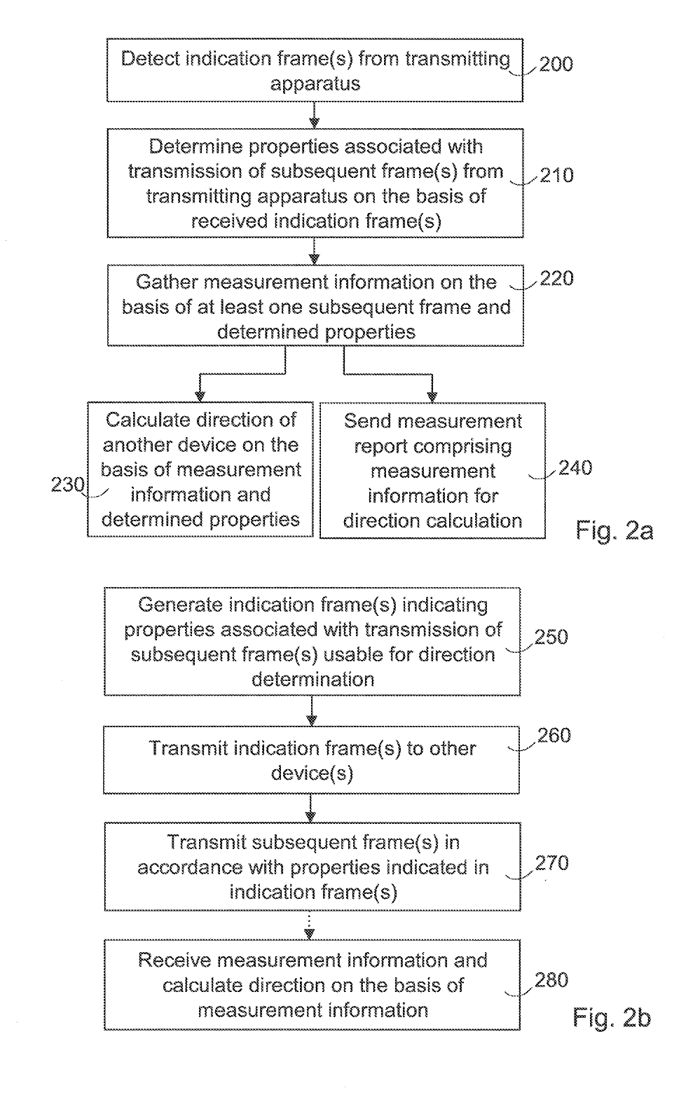

FIGS. 2a and 2b illustrate methods according to some embodiments. The methods of FIGS. 2a and 2b may be applied as control algorithm(s) in one or more apparatuses, such as the mobile device 10 and/or the AP 20, configured to calculate direction of a radio signal source and/or transmit signal usable for direction calculation.

In FIG. 2a, at least one indication frame is received and detected 200 from a transmitting apparatus, referring generally to an apparatus sending signals usable for direction calculation, such as an access point or another radio device. The indication frame may be a new message or an addition to an already specified message.

Properties associated with transmission of at least one subsequent frame from the transmitting apparatus and usable for direction calculation are determined 210 on the basis of the at least one indication frame. This is to be understood broadly to cover any information facilitating the receiving apparatus to detect a signal usable for direction calculation, gather information for direction calculation, and/or carry out direction calculation, which may generally refer to generation of a direction estimate.

At least one subsequent frame usable for direction calculation purposes from the transmitting apparatus is received and detected. These subsequent frames could also be referred to as direction measurement sample frames, for example. Such subsequent frame may be received substantially immediately as a next frame after the indication frame, or there may be further delay and/or other frames in between the indication frame and the subsequent frame. Measurement information for direction calculation is gathered 220 on the basis of the at least one subsequent frame and the determined properties. This is to be understood broadly to cover any required actions to obtain information, suitable as such or after further processing for direction calculation, regarding the subsequent frame(s) on the basis of the determined properties.

The at least one subsequent frame may be further analysed on the basis of the determined properties for direction calculation. In some embodiments, the apparatus carrying out the method of FIG. 2a may calculate 230 at least relative direction of the transmitting apparatus on the basis of the measurement information and the determined properties.

In some embodiments, the direction calculation is performed in another apparatus, such as the transmitting apparatus. This option is also illustrated by block 240, which may replace block 230, or blocks 230 and 240 may represent alternative options selectable e.g. on the basis of the information in the indication frame. A measurement report comprising the measurement information is sent 240 to the other apparatus to calculate direction. For example, measurement results as such or after some further processing and/or analysis may be sent back to the transmitting apparatus.

FIG. 2b illustrates features for a transmitting apparatus, such as the AP 20, providing signal usable for direction calculation purposes. At least one indication frame is generated 250, indicating properties associated with transmission of at least one subsequent frame usable for direction calculation. The indication frame(s) are transmitted 260 for at least one other apparatus, such as the mobile device 10 carrying out the method of FIG. 2a. The indication frame may be transmitted in an individually addressed message or a group address, i.e. a multicast or broadcast message. The indication frame may be transmitted periodically or upon request.

Subsequent frame(s) usable for direction calculation in the at least one other apparatus are transmitted 270 in accordance with the properties indicated in the indication frame.

In some embodiments, the transmitting apparatus waits for a measurement report, prepared on the basis of the indication frame and the subsequent frame(s), from the at least one other apparatus after block 270. In response to receiving 280 such measurement report, such as the measurement report sent according to block 240 of FIG. 2a, the transmitting apparatus calculates at least relative direction of the transmitting apparatus in relation to the receiving apparatus and/or direction of the receiving apparatus in relation to the transmitting apparatus. The calculated direction information may be sent to the apparatus which transmitted the measurement report. For example, the AP 20 may thus calculate direction information on behalf of mobile devices 10, 30.The indication frame may be used in various ways for facilitating the direction finding in the receiving apparatus (or the transmitting apparatus), some non-limiting example embodiments being illustrated below. The property information in the indication frame may comprise information assisting e.g. the mobile device 10 to detect 210, 220 which of the subsequently received frames are usable as samples for direction calculation.

In some embodiments, the indication frame indicates the type of support for direction calculation available from the transmitting device. For example, the indication frame may indicate if the transmitting apparatus supports transmission of (or will transmit) samples for direction calculation from multiple antenna elements, thus enabling calculation of angle of departure (AoD) based direction calculation in the receiving device. In some embodiments, the indication frame comprises information on properties of the antenna elements and how the transmitting apparatus is switching between the antenna elements.

Thus, a mechanism is available for providing information from a signal source for receiving devices to prepare for subsequent frames enabling direction calculation. There may be many direction calculation methods and supporting signals available, and the use of the indication frame enables the receiving device to detect the method/signal provided by the transmitting apparatus. The receiving device may thus beforehand adapt to the related properties and capabilities of the transmitting apparatus.

As indicated in FIG. 1, the mobile device 10 may comprise a controller 12 configured to control at least some of the features illustrated in FIG. 2a and/or 2b on the basis of information received via an RF module 14. The controller 12 may encompass a direction estimator which is capable of using the indication frame information and the information in the subsequent frame(s) and one or more antenna elements to calculate relative direction of a transmitter, such as the AP 20. An apparatus comprising the controller 12 may also be arranged to implement at least some of the further related embodiments illustrated below. The operation of the controller 12 and/or the RF module 14 may be configured on the basis of the property data in the indication frame on the subsequent messages usable for direction calculation. The direction information may be used for estimating the location of the mobile device 10. The mobile device 10 may be arranged to monitor for and receive the indication frames and subsequent frames from a number of neighbouring devices, and perform direction calculation e.g. for all these neighbouring devices, to further facilitate maintenance of accurate location information. The location information may be applied for various purposes, for example for location based applications or for optimizing handover decisions.

Similarly, the AP 20 may comprise a controller configured to control features of blocks 250 to 270. In some embodiments, such controller, or a specific direction estimator, in the AP 20 may be configured to perform block 280 involving the direction estimation.

Let us now further study some example embodiments related to the facilitating direction calculation on the basis of the indication frame. One or more of these further illustrated features, in various combinations, may be applied in an apparatus configured to carry out features of FIG. 2a and/or 2b. For simplicity reasons, references are mainly made to embodiments in which also the direction is calculated in the apparatus receiving the indication frame and the subsequent frame(s). However, it is to be appreciated that many of the embodiments below may be applied also when the transmitting apparatus calculates the distance on the basis of the measurement information from the receiving apparatus.

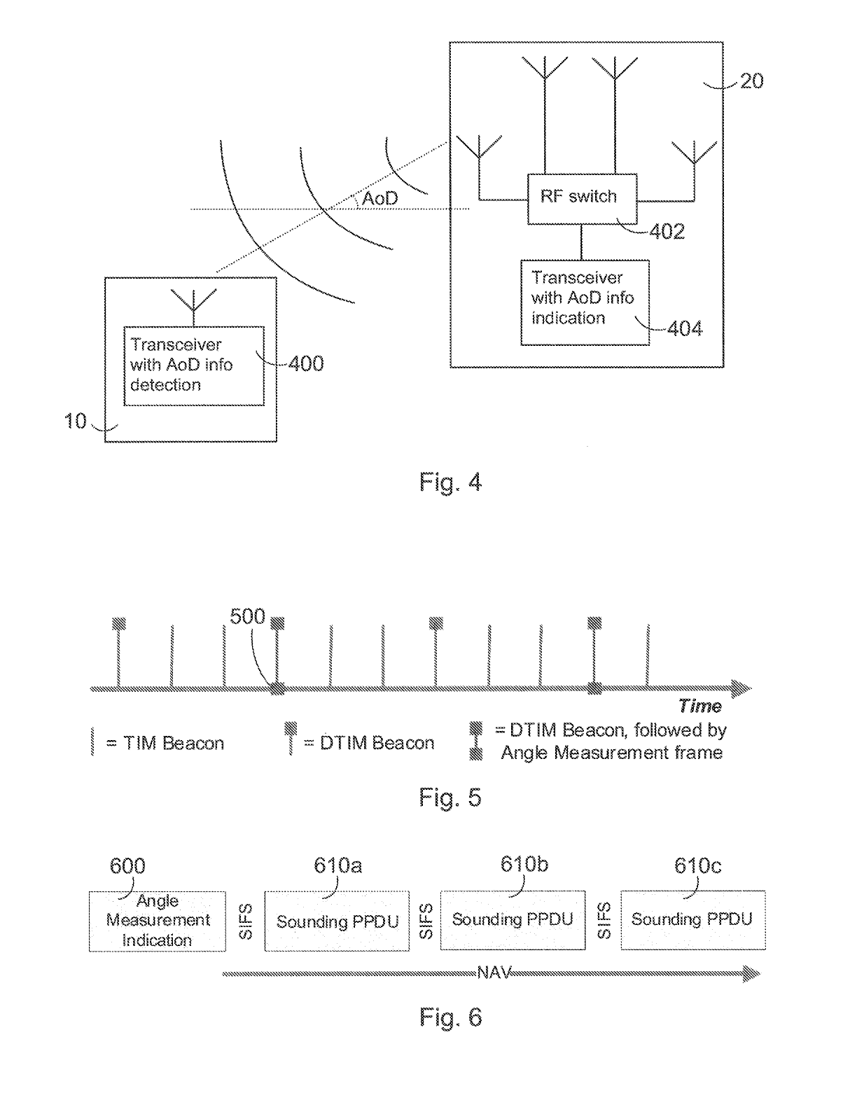

There are many direction calculation techniques available for application with the present features and for calculating 230 at least the relative direction. As some examples, FIGS. 3 and 4 illustrate principles of the AoA and AoD based direction calculation, respectively, applying antenna switching. When the number of antenna elements is larger than the number of RF chains, an antenna element selection procedure may be used to select appropriate transmit or receive antenna elements for direction calculation purposes. This may involve training with all antenna elements, which can be obtained by sending multiple frames. To avoid channel distortion between frames, these frames are transmitted consecutively. In some cases it may be possible to switch between antenna elements even during a single frame.

Calculation of AoA is based on time difference of signal copies received by multiple physically separated antenna elements, and the time difference is due to variable propagation channel lengths. The practical estimation is typically based on secondary effects to the signal, such as the resulting phase difference of the signal copies. As the signal phase change is known due to use of known signal, the signal phase differences obtained from different receiving antenna elements can be used to calculate the direction of arrival of the signal.

FIG. 3 illustrates AoA detection, where the mobile device 10 may measure the signal from the transmitting apparatus, such the AP 20, at each antenna element in an antenna array of the mobile device 10. Amplitude and phase measurements may be recorded by cycling an RF switch 302 through each antenna element in the array. The mobile device 10 may then calculate an AoA for the signal using the recorded samples and parameters related to the antenna array. The antenna array parameters may pertain the composition, configuration and placement of antenna elements within the antenna array, and may be set in the device 10, for example, as part of the device manufacturing process.

As further illustrated, the transceiver 306 of the AP 20 is enhanced to transmit an indication frame, indicating at least support for AoA detection. The transceiver 304 of the mobile device 10 is arranged to receive the indication frame, and the mobile device 10 is arranged to control switching of receiving antenna elements and AoA detection in response to the indication frame. On the basis of the indication frame, the mobile device 10 may identify that the subsequent frames are usable for performing AoA calculation prior to initiating the process. Further, the indication frame may include information enabling the mobile device to detect what signal content to measure, including the length of the signal content to measure, e.g. by number of frames.

FIG. 4 illustrates AoD detection for a signal transmitted from the example transmitting apparatus AP 20. In this configuration the AP 20 may transmit frames for AoD detection and execute antenna element switching by a switcher 402 during the transmission of a subsequent frame or between subsequent frames. The transceiver 404 of the AP 20 is arranged to transmit information indicating support for AoD and properties related to the transmission of at least subsequent frame using multiple antenna elements. The mobile device's transceiver 400 is arranged to detect the indication frame, which may indicate antenna array properties and how the AP 20 is switching between the antenna elements. The mobile device 10 may then receive and apply subsequent frame(s) for facilitating AoD detection according to the information in the indication frame. For example, the mobile device 10 may execute specific amplitude and phase sampling during reception of these subsequent frames. The mobile device 10 may then utilize the amplitude and phase samples, along with antenna array parameter information in the indication frame, to calculate the AoD of the signal from the AP 20. In some embodiments, at least some of the fixed parameters related to the physical configuration of the antenna array of the transmitting apparatus 20 may be obtained from another entity, such from a server via a wireless link to the Internet.

In case of wideband signals, such as the WLAN signals, channel impulse responses related to different RX/TX antenna elements may be measured by the receiver 304, 400 before performing the direction calculation. By using a time-domain based method, the impulse responses can be obtained by transmitting a pseudo-noise sequence to/from each RX/TX antenna element and running an autocorrelation process at the receiver. The peaks in the impulse response correspond to copies of the same signal received through different transmission paths. The AoA/AoD related to a particular transmission path is obtained by computing the phase difference between the copies of the same peak in impulse responses obtained using different RX/TX antenna element. In the localization embodiments one is usually only interested on the direct path and therefore only the AoA/AoD related to the first peak is considered. The additional peaks can however be used to estimate the quality of the direction estimate. Already known methods may be applied for calculating the AoA/AoD on the basis of pseudo-noise sequences and impulse responses.

Frequency-domain based channel calculation requires a fast-fourier transformation of the received data for each antenna element and calculation of the channel estimate for the transmitted subcarriers from the known transmitted frequency domain signal. In this case the difference in propagation length to the antenna elements is observed in the phase difference between channel estimates of the same subcarriers between antenna elements. The received samples for the fast-fourier transform are selected from known or estimated location of the received pseudorandom sequence.

The indication frame may be transmitted 260 periodically and/or in a response to an individually addressed signalling request frame. The indication frame may comprise an identifier of the transmitting apparatus, on the basis of which e.g. the mobile device 10 may detect that it is estimating the direction of the AP 20.

FIG. 5 illustrates periodical transmission indication frames in a WLAN system. The indication frame, in the example of FIG. 5 referred to as “Angle Measurement Indication” frame, is transmitted 500 periodically after a delivery traffic indication map (DTIM) beacon. The Angle Measurement Indication frame may be management frame and transmitted after every X^{th} DTIM Beacon. The mobile device 10 may be arranged to request the transmitters' order and exact transmission timings of the indication frames, such as Angle Measurement Indication frames, from a dedicated server.

The AP 20 may be arranged to transmit the Angle Measurement Indication frame to a group address. The Angle Measurement Indication frame may include at least one of the transmitter MAC address, properties of transmit antenna elements in case of AoD calculation support, and the amount of subsequent physical layer convergence procedure (PLCP) protocol data units (PPDUs) usable for direction calculation. This information may be applied 210 to 240 by the receiving STAs to detect the transmitting STA and to gather measurement information to calculate the angle to the STA.

The subsequent frame used for direction calculation 230, 270 may also be transmitted periodically and/or as a response to an individually addressed signalling request, some further examples being illustrated below.

According to some embodiments, the subsequent frames are sounding frames used for channel estimation. In an example embodiment, as illustrated in FIG. 6, each Angle Indication Measurement frame 600 may be followed by one or more sounding PPDUs 610a, 610b, 610c (separated by the WLAN short interframe space (SIFS) period). The Sounding PPDUs do not contain MAC address, i.e. the transmitting apparatus is in this embodiment identified only on the Angle Measurement Indication frame. The Duration field of the Angle Measurement Indication frame may be set to protect the subsequent Sounding PPDUs.

Sounding PPDUs may be used in 802.11n systems to recover a full characterization of a multiple input multiple output (MIMO) channel. A sounding PPDU in 802.11n systems is a PPDU for which the SOUNDING parameter of a corresponding RXVECTOR or TXVECTOR has the value ‘SOUNDING’. Sounding PPDUs may be used in 802.11n for channel sounding by procedures referred to as Transmit Beamforming and Antenna Selection. These methods may be applied to calculate the AoA or AoD in connection with the presently disclosed use of the indication frame.

According to IEEE 802.11n, implicit and explicit feedback procedures using sounding PPDUs may be applied for Beamforming. In the implicit feedback procedure it is assumed that the channel is reciprocal and thus the transmitting apparatus may send sounding PPDUs to the receiving apparatus which can use those to estimate channel properties for its own transmission. The basic process of implicit feedback is based on requesting sounding PPDUs: For example, the mobile device 10 sends a training request to the AP 20, which sends a sounding PPDU in response to the request. The mobile device 10 computes the channel characteristics based on the received sounding PPDU and uses the resulting channel estimate to compute a channel matrix for direction calculation. The mobile device 10 may transmit one or more sounding PPDUs for computing channel matrix for a larger number of antenna elements than supported in the single sounding packet.

In the explicit feedback procedure the receiving apparatus may estimate the channel and report the estimated channel back to the transmitting apparatus. For example, the mobile device 10 sends a sounding PPDU to the AP 20. On reception of the sounding PPDU, the AP 20 uses the resulting channel estimate to compute a channel matrix. The AP 20 may use this information for facilitating direction calculation, and report the computed channel matrix back to the mobile device 10 for direction calculation. The mobile device 10 may transmit one or more sounding PPDUs for computing channel matrix for a larger number of antenna elements than supported in the single sounding PPDU.

Antenna element switching was already illustrated in connection with FIGS. 3 and 4, and the frames for the AoA or AoD detection may be IEEE 802.11n sounding PPDUs.

In a further embodiment related to AoA detection illustrated in FIG. 3, a first RF chain is used to obtain samples from multiple antenna elements while a second RF chain is used to obtain samples from a single antenna element (i.e. not via the RF switch 302). The second RF chain may thus be used as a reference to remove channel distortion between sounding frames. Because of using two RF chains there is no need for them to be accurately calibrated for obtaining an accurate AoA estimate. If several RF chains are utilized to measure multiple antenna elements, calibration of each RX chain has to be performed for obtaining comparable samples for AoA calculation purposes.

One or more RF chains may be used also in connection with the AoD detection illustrated in FIG. 4. If several TX chains are utilized in the transmitting apparatus 20, calibration of TX chains is needed for obtaining comparable samples for AoD calculation purposes.

It is to be appreciated that number of antenna elements, the number of RF chains and the switching process (e.g. number and positioning of switches) may be varied. Also, it is possible to apply a combination of implementations, e.g. compute both AoA and AoD illustrated in connection with FIGS. 3 and 4.

In an embodiment, an acknowledgement to a quality of service frame of sub-type ‘no data’, referred to as “QoS-Null” frame in IEEE 802.11, is applied as the subsequent frame for direction calculation. The QoS-Null and Acknowledgement (ACK) transmission procedure may thus deliver samples for AoA calculation between a time interval measures, and the mobile device 10 may be arranged to calculate the AoA on the basis of these received acknowledgment PPDUs.

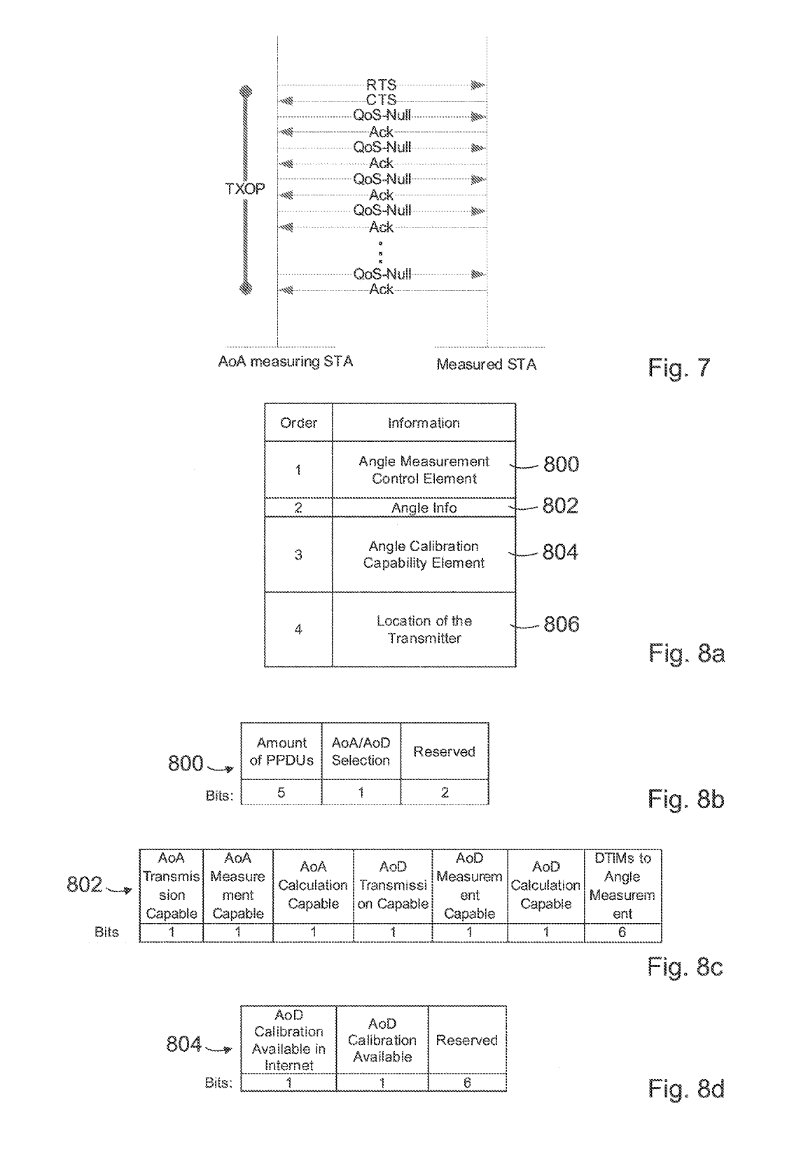

As illustrated in FIG. 7, the QoS-Null and ACK message exchange during a transmission opportunity (TXOP) may begin with a request to send (RTS)—clear to send (CTS) transmission. Alternatively, only the QoS-Null and the ACK frames may be transmitted. It is recommended that the RTS CTS or QoS-Null frame is transmitted at the lowest transmission rate. The lowest transmission rate distributes the MAC header duration field that is required to distribute the network allocation vector (NAV) information. In one embodiment, the mobile device 10, as the AoA measuring STA, may start to transmit multiple QoS-Null frames to the AP 20 in response to detecting that this measured STA does not support sounding. However, the QoS-Null and ACK exchange could be used to obtain samples for direction measurement even without a preceding indication frame.

It will be appreciated that the above procedures and frame types represent only some examples for arranging the transmission of subsequent frames usable for direction calculation in WLAN, and various other already specified frames, or a completely new frame may be applied for WLANs or other systems. Any other format of frames and WLAN PPDUs suitable for direction calculation may be used. This allows, for example, dedicated PPDUs to be defined for measurement purposes that may enable better channel utilization or even switching of antenna elements within a single PPDU. As a further example, a beacon message may be applied to carry at least some of the presently disclosed information for the indication frame.

FIG. 8a illustrates example information elements, at least some of which may be applied in the indication frame, such as the Angle Measurement Indication frame illustrated above.

FIG. 8b illustrates example fields for the Angle Measurement Control element 800 of FIG. 8a. The Amount of PPDUs may be an unsigned integer and may contain the amount of frames, such as Sounding PPDUs, following the Angle Measurement Indication frame and usable for direction calculation.

The AoA/AoD Selection indicates whether AoA or AoD will be supported by the consequent frames. For example, the AoA/AoD Selection field may be defined to have the value ‘1’ to indicate that the TX antenna elements are switched within or between transmitted sounding PPDUs, i.e. that AoD detection will be supported. The field may be set to ‘0’ to indicate that the sounding PPDUs are transmitted from a single antenna element, i.e. AoA calculation support. It is to be noted that the mobile device 10 may also be configured to perform multiple AoA detections concurrently in case of multiple antenna elements.

FIG. 8c illustrates example fields for the Angle Info element in FIG. 8a. The AoA Transmission Capable field may be set to ‘1’ to indicate that the transmitting apparatus 20 is capable to transmit a frame on the basis of which the AoA may be calculated, e.g. to transmit Sounding PPDUs for AoA measurement. Otherwise this field may be set to ‘0’. In some embodiments, the Angle Info element is included in beacon frame, whereby the receiving mobile device 10 may detect that the transmitting apparatus, e.g. the AP 20, is arranged to transmit an Angle Measurement Indication frame on the basis of which the mobile device 10 may calculate the AoA. The AoA Measurement Capable field may be used to indicate if the transmitting apparatus is capable to measure AoA on the basis of the transmitted frames.

The AoA Calculation Capable field may indicate if the transmitting apparatus is capable to calculate the AoA on the basis of the measured AoA parameters or on the basis of a received AoA measurement frame (e.g. in case another device will be transmitting AoA measurement frames).

The AoD Capable field may indicate that the transmitting apparatus is capable to transmit a frame for AoD calculation e.g. by transmitting Sounding PPDUs and Angle Measurement Indication frame on the basis of which the receiving STAs may calculate the AoD.

The AoD Measurement Capable field may indicate if the transmitting apparatus is capable to measure AoD on the basis of the transmitted frames.

The AoD Calculation Capable field may indicate if the transmitting apparatus is capable to calculate the AoD on the basis of the received AoD measurement frame or from the measured AoD parameters. The DTIMs to Angle Measurement field may be used in Beacon messages to indicate the amount of DTIMs Beacons to Angle Measurement Indication frame transmission. The value ‘0’ may indicate that the Angle Measurement Indication is transmitted after the next DTIM Beacon. The DTIMs to Angle Measurement field may be set to ‘0’, when AoD Capable and AoA Capable fields are set to ‘0’.

FIG. 8d illustrates example fields for the Angle Calibration element 804 in FIG. 8a. The AoD Calibration Available in Internet field may be set to ‘1’ to indicate that calibration parameters required to be able to calculate the AoD are available in Internet and set to 0 otherwise. The AoD Calibration Available field may be set to ‘1’ to indicate that calibration parameters required to calculate AoD may be requested by a separate request, such as an AoDAntennaConfiguration.request and received with AoDAntennaConfiguration.response frames, otherwise the field may be set to ‘0’.

The Location of the Transmitter element 806 of FIG. 8a may include information on location of the device transmitting the indication frame.

In an embodiment, the indication frame is used to request a receiving apparatus to perform or provide 240 a measurement report for a specific type of a direction measurement. For example, the Angle Measurement Indication frame may request the individually addressed mobile device 10 to perform specific type of AoA or AoD direction measurement. It is to be appreciated that the indication frame may be used to carry out various other and further types or parameters affecting the direction measurement related operations of the receiving apparatus.

In another embodiment, the mobile device 10 is arranged to return the calculated angle and/or further information, such as the location of the device 10.

Embodiments of the present invention and means to carry out these embodiments in an apparatus, such as the mobile device 10 and/or a wireless access device 20, may be implemented in software, hardware, application logic or a combination of software, hardware and application logic. In an example embodiment, the application logic, software or an instruction set is maintained on any one of various conventional computer-readable media.

In one example embodiment, there may be provided circuitry configured to provide at least some functions illustrated above, such as the features illustrated in FIG. 2a and/or 2b. As used in this application, the term ‘circuitry’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware.

Although single enhanced entities were depicted above, it will be appreciated that different features may be implemented in one or more physical or logical entities. For instance, the apparatus may comprise a specific functional module for carrying one or more of the blocks in FIG. 2a and/or 2b. In some embodiments, a chip unit or some other kind of hardware module is provided for controlling a radio device, such as the mobile device 10 or an AP 20.

In some embodiments, the property data in the indication frame associated with transmission of the subsequent frame(s) usable for direction calculation comprise or are stored as data structures affecting operation of one or more applications. For example, the mobile device 10 may store at least some of the received property data to a memory, and property data retrieved from the memory affects the operation of the controller 12.

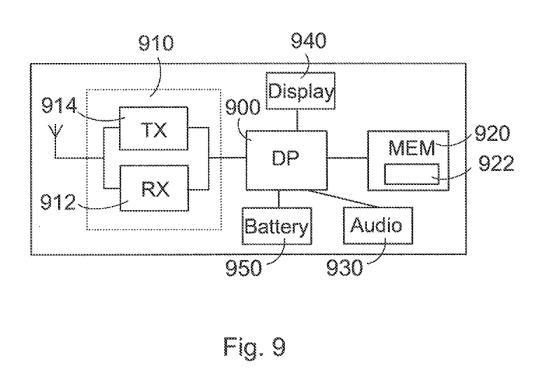

FIG. 9 is a simplified block diagram of high-level elements of a mobile communications device according to an embodiment. The device may be configured to function as the mobile device 10, and carry out at least some of the functions illustrated above for the mobile device 10.

In general, the various embodiments of the device can include, but are not limited to, cellular telephones, personal digital assistants (PDAs), laptop/tablet computers, digital book readers, imaging devices, gaming devices, media storage and playback appliances, Internet access appliances, as well as other portable units or terminals that incorporate wireless communications functions.

The device comprises a data processing element DP 900 with at least one data processor and a memory 920 storing a program 922. The memory 920 may be implemented using any data storage technology appropriate for the technical implementation context of the respective entity. By way of example, the memory 920 may include non-volatile portion, such as EEPROM, flash memory or the like, and a volatile portion, such as a random access memory (RAM) including a cache area for temporary storage of data. The DP 900 can be implemented on a single-chip, multiple chips or multiple electrical components. The DP 900 may be of any type appropriate to the local technical environment, and may include one or more of general purpose computers, special purpose computers (such as an application-specific integrated circuit (ASIC) or a field programmable gate array FPGA), digital signal processors (DSPs) and processors based on a multi-processor architecture, for instance.

The device may comprise at least one radio frequency transceiver 910 with a transmitter 914 and a receiver 912. However, it will be appreciated that in many cases a mobile communications device is a multimode device. By way of illustration, the electronic device may comprise radio units 910 to operate in accordance with any of a number of second, third and/or fourth-generation communication protocols or the like. For example, the device may operate in accordance with one or more of GSM protocols, 3G protocols by the 3GPP 3G protocols, CDMA2000 protocols, 3GPP Long Term Evolution (LTE) protocols, short-range wireless protocols, such as the Bluetooth, and the like. As already illustrated above, the device may comprise multiple transmitting and/or receiving antenna elements (not shown in FIG. 9) which are switched between subsequent frames or within a subsequent frame to facilitate direction measurements.

The DP 900 may be arranged to receive input from UI input elements, such as an audio input circuit connected to a microphone and a touch screen input unit, and control UI output, such as audio circuitry 930 connected to a speaker and a display 940 of a touch-screen display. The device also comprises a battery 950, and may also comprise other UI output related units, such as a vibration motor for producing vibration alert.

It will be appreciated that the device typically comprises various further elements, such as further processor(s), further communication unit(s), user interface components, a media capturing element, a positioning system receiver, sensors, such as an accelerometer, and a user identity module, not discussed in detail herein. The device may comprise chipsets to implement at least some of the high-level units illustrated in FIG. 9. For example, the device may comprise a power amplification chip for signal amplification, a baseband chip, and possibly further chips, which may be coupled to one or more (master) data processors.

An embodiment provides a computer program embodied on a computer-readable storage medium. The program, such as the program 922 in the memory 920, may comprise computer program code configured to, with the at least one processor, cause an apparatus, such as the device 10, 20, 30 or the device of FIG. 9, to perform at least some of the above-illustrated direction calculation facilitation related features illustrated in connection with FIGS. 2a to 8. In the context of this document, a “computer-readable medium” may be any media or means that can contain, store, communicate, propagate or transport the instructions for use by or in connection with an instruction execution system, apparatus, or device, such as a computer, with some examples of a computer being described and depicted in connection with FIG. 9. A computer-readable medium may comprise a tangible and non-transitory computer-readable storage medium that may be any media or means that can contain or store the instructions for use by or in connection with an instruction execution system, apparatus, or device, such as a computer.

Although the specification refers to “an”, “one”, or “some” embodiment(s) in several locations, this does not necessarily mean that each such reference is to the same embodiment(s), or that the feature only applies to a single embodiment. Single features of different embodiments may also be combined to provide other embodiments. If desired, at least some of the different functions discussed herein may be performed in a different order and/or concurrently with each other. Furthermore, if desired, one or more of the above-described functions may be optional.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1-52. (canceled)

53. A method, comprising:
detecting, by an apparatus, at least one indication frame from another apparatus,
determining properties associated with transmission of at least one subsequent frame from the another apparatus on the basis of the at least one indication frame, and
gathering measurement information for direction calculation on the basis of the determined properties and the at least one subsequent frame from the another apparatus.

54. The method of claim 53, further comprising: calculating at least relative direction of the another apparatus on the basis of the measurement information and the determined properties, or
sending a report comprising the measurement information to an apparatus for direction calculation.

55. The method of claim 53, wherein the at least one subsequent frame is at least one of a sounding frame and an acknowledgement to a quality of service frame of sub-type ‘no data’.

56. The method of claim 53, wherein the indication frame comprises at least one of:
properties of transmit antenna elements and the amount of subsequent frames usable for calculating the at least relative direction of the another apparatus.

57. The method of claim 53, wherein the at least one subsequent frame comprises at least two frames transmitted or received by different antenna elements.

58. The method of claim 57, wherein the indication frame indicates that subsequent frames are transmitted from a plurality of antenna elements.

59. The method of claim 53, wherein the method is for a wireless local area network.

60. A method, comprising: generating at least one indication frame indicating properties associated with transmission of at least one subsequent frame usable for direction calculation,
transmitting the at least one indication frame for at least one other apparatus, and
transmitting at least one subsequent frame usable for direction calculation in the at least one other apparatus in accordance with the properties indicated in the indication frame.

61. The method of claim 60, further comprising:
receiving, after the at least one subsequent frame, a report comprising measurement information generated on the basis of the indication frame and the at least one subsequent frame from the another apparatus, and
performing direction calculation on the basis of the measurement information.

62. The method of claim 60, wherein the at least one subsequent frame is at least one of a sounding frame and an acknowledgement to a quality of service frame of sub-type ‘no data’.

63. The method of claim 60, wherein the at least one subsequent frame comprises at least two subsequent frames and the indication frame indicates that the at least two subsequent frames are transmitted from a plurality of antenna elements.

64. An apparatus, comprising:
at least one processor; and
at least one memory including computer program code,
the at least one memory and the computer program code configured to, with the at least one processor, cause the apparatus at least to:
detect at least one indication frame from another apparatus,
determine properties associated with transmission of at least one subsequent frame from the another apparatus on the basis of the at least one indication frame, and
gather measurement information for direction calculation on the basis of the determined properties and the at least one subsequent frame from the another apparatus.

65. The apparatus of claim 64, wherein the apparatus is further configured to:
calculate at least relative direction of the another apparatus on the basis of the measurement information and the determined properties, or
send a report comprising the measurement information to an apparatus for direction calculation.

66. The apparatus of claim 64, wherein at least one subsequent frame is at least one of a sounding frame and an acknowledgement to a quality of service frame of sub-type ‘no data’.

67. The apparatus of claim 64, wherein the indication frame comprises at least one of:
properties of transmit antenna elements and the amount of subsequent frames usable for calculating the at least relative direction of the another apparatus.

68. The apparatus of claim 64, wherein the at least one subsequent frame comprises at least two frames transmitted or received by different antenna elements.

69. The apparatus of claim 68, wherein the indication frame indicates that subsequent frames are transmitted from a plurality of antenna elements.

70. An apparatus, comprising:
at least one processor; and
at least one memory including computer program code,
the at least one memory and the computer program code configured to, with the at least one processor, cause the apparatus at least to:
generate at least one indication frame indicating properties associated with transmission of at least one subsequent frame usable for direction calculation,
transmit the at least one indication frame for at least one other apparatus, and
transmit at least one subsequent frame usable for direction calculation in the at least one other apparatus in accordance with the properties indicated in the indication frame.

71. The apparatus of claim 70, wherein the apparatus is further configured to:
receive, after the at least one subsequent frame, a report comprising measurement information generated on the basis of the indication frame and the at least one subsequent frame from the another apparatus, and
perform direction calculation on the basis of the measurement information.

72. The apparatus of claim 70, wherein the at least one subsequent frame is at least one of a sounding frame and an acknowledgement to a quality of service frame of sub-type ‘no data’.

73. The apparatus of claim 72, wherein the at least one subsequent frame comprises at least two subsequent frames and the indication frame indicates that the at least two subsequent frames are transmitted from a plurality of antenna elements.
